(19) United States
(12) Patent Application Publication
(10) Pub. No.: US 2005/0209849 A1
(43) Pub. Date: Sep. 22, 2005

(54) System and method for automatically cataloguing data by utilizing speech recognition procedures

(75) Inventors: Gustavo Abrego, San Jose, CA (US); Lex Olorenshaw, Half Moon Bay, CA (US); Lei Duan, San Jose, CA (US); Xavier Menendez-Pidal, Los Gatos, CA (US)

Correspondence Address: Gregory J. Koerner;Redwood Patent Law, 1291 East Hillsdale Boulevard, Suite 205, Foster City, CA, 94404, US

(73) Assignee: Sony Corporation and Sony Electronics Inc.

(21) Appl. No.: 10/805,781

(22) Filed: Mar. 22, 2004

(51) Int. Cl. G10L 15/00

(52) U.S. Cl. 704/235

(57) ABSTRACT

A system and method for automatically cataloguing data by utilizing speech recognition procedures includes an electronic device that captures audio/video data and corresponding verbal narration. A speech recognition engine coupled to the electronic device automatically performs a speech recognition process upon the audio/video data and verbal narration to generate labels that correspond to respective subject matter locations in the audio/video data. A label manager of the electronic device manages a label mode for generating and storing the foregoing labels. The label manager also controls a label search mode during which a system user utilizes the labels to automatically locate corresponding subject matter locations in the captured audio/video data.

### BACKGROUND SECTION

1. Field of Invention

This invention relates generally to electronic speech recognition systems, and relates more particularly to a system and method for automatically cataloguing data by utilizing speech recognition procedures.

2. Description of the Background Art

Implementing robust and effective techniques for system users to interface with electronic devices is a significant consideration of system designers and manufacturers. Voice-controlled operation of electronic devices may often provide a desirable interface for system users to control and interact with electronic devices. For example, voice-controlled operation of an electronic device may allow a user to perform other tasks simultaneously, or can be advantageous in certain types of operating environments. In addition, hands-free operation of electronic devices may also be desirable for users who have physical limitations or other special requirements.

Hands-free operation of electronic devices may be implemented by various speech-activated electronic devices. Speech-activated electronic devices advantageously allow users to interface with electronic devices in situations where it would be inconvenient or potentially hazardous to utilize a traditional input device. However, effectively implementing such speech recognition systems creates substantial challenges for system designers.

For example, enhanced demands for increased system functionality and performance require more system processing power and require additional hardware resources. An increase in processing or hardware requirements typically results in a corresponding detrimental economic impact due to increased production costs and operational inefficiencies.

Furthermore, enhanced system capability to perform various advanced operations provides additional benefits to a system user, but may also place increased demands on the control and management of various system components. Therefore, for at least the foregoing reasons, implementing a robust and effective method for a system user to interface with electronic devices through speech recognition remains a significant consideration of system designers and manufacturers.

### SUMMARY

In accordance with the present invention, a system and method are disclosed for automatically cataloguing data by utilizing speech recognition procedures. In one embodiment, a system user utilizes an electronic device to capture audio/video data (AV data) while simultaneously providing a verbal narration that is recorded as part of the AV data. In certain embodiments, when a label manager instructs the electronic device to enter a label mode, a speech recognition engine of the electronic device responsively performs speech recognition procedures upon the recorded AV data (including the verbal narration) to automatically generate corresponding text labels.

In certain embodiments, the label manager may optionally instruct a post processor to perform appropriate post-processing functions on the text labels. For example, the post processor may perform a validation procedure using one or more confidence measures to eliminate invalid text strings that fail to satisfy certain pre-determined criteria. The text labels are then stored in any appropriate manner. For example, the label manager may store each of the text labels at different subject matter locations in the AV data depending upon where the corresponding original narration occurred. The text labels may also be stored separately along with certain meta-information (such as video timecode) that identifies specific subject matter locations in the AV data that correspond to respective text labels.

In a label search mode, the label manager coordinates label search procedures for the electronic device. In certain embodiments, the label manager generates a label-search graphical user interface (GUI) upon a display of the electronic device for enabling a system user to utilize the text labels to thereby locate corresponding sections of the AV data. In certain embodiments, the label search GUI includes, but is not limited to, a list of text labels along with corresponding respective thumbnail images of associated video locations in the AV data.

A system user may then select a desired search label by using any appropriate means. After a search label has been selected by the system user, then the label manager instructs the electronic device to automatically locate and display a corresponding section from the AV data. For at least the foregoing reasons, the present invention effectively provides an improved system and method for automatically cataloguing data by utilizing speech recognition procedures.

### BRIEF DESCRIPTION OF THE DRAWINGS

FIG. 1 is a block diagram for one embodiment of an electronic device, in accordance with the present invention;

FIG. 2 is a block diagram for one embodiment of the memory of FIG. 1, in accordance with the present invention;

FIG. 3 is a block diagram for one embodiment of the speech recognition engine of FIG. 2, in accordance with the present invention;

FIG. 4 is a block diagram illustrating functionality of the speech recognition engine of FIG. 3, in accordance with one embodiment of the present invention;

FIG. 5 is a block diagram for one embodiment of the dictionary of FIG. 3, in accordance with the present invention;

FIG. 6 is a diagram illustrating an exemplary recognition grammar of FIG. 3, in accordance with one embodiment of the present invention;

FIG. 7 is a block diagram illustrating an information flow, in accordance with one embodiment of the present invention;

FIG. 8 is a flowchart of method steps for performing an automatic cataloguing procedure in a real-time mode, in accordance with one embodiment of the present invention;

FIG. 9 is a flowchart of method steps for performing an automatic cataloguing procedure in a non-real-time mode, in accordance with one embodiment of the present invention; and

FIG. 10 is a flowchart of method steps for performing a label search procedure, in accordance with one embodiment of the present invention.

### DETAILED DESCRIPTION

The present invention relates to an improvement in speech recognition systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for automatically cataloguing data by utilizing speech recognition procedures, and includes an electronic device that captures audio/video data and corresponding verbal narration. A speech recognition engine coupled to the electronic device automatically performs a speech recognition process upon the audio/video data and verbal narration to generate text labels that correspond to respective subject matter locations in the audio/video data. A label manager of the electronic device manages a label mode for generating and storing the foregoing text labels. The label manager also controls a label search mode during which a system user utilizes the text labels to automatically locate the corresponding subject matter locations in captured audio/video data.

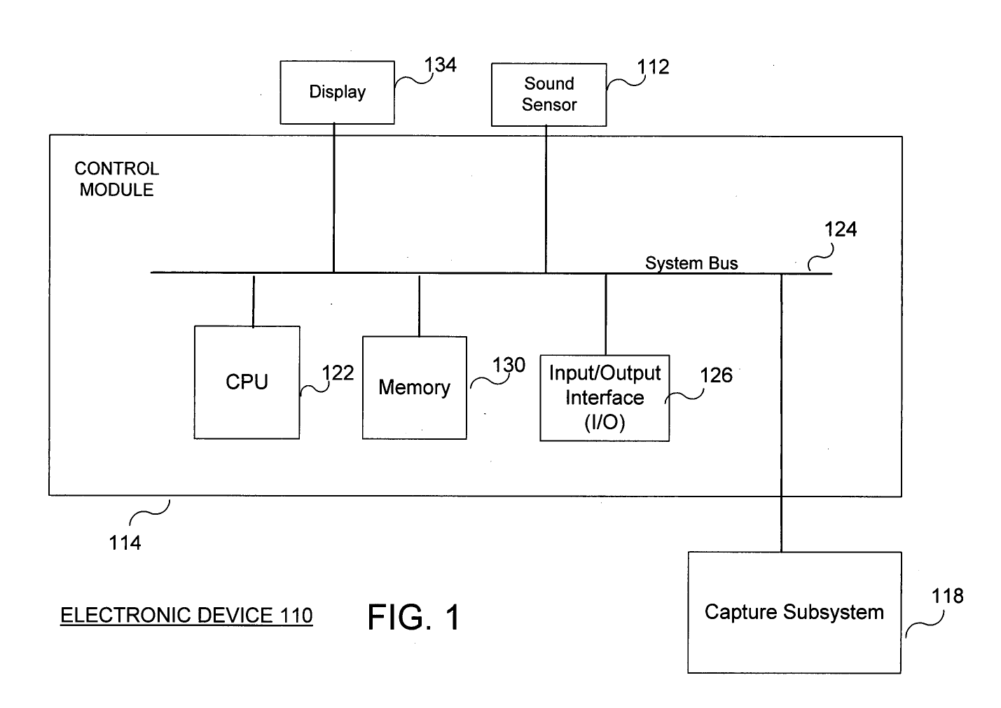

Referring now to FIG. 1, a block diagram for one embodiment of an electronic device 110 is shown, according to the present invention. The FIG. 1 embodiment includes, but is not limited to, a sound sensor 112, a control module 114, a capture subsystem 118, and a display 134. In alternate embodiments, electronic device 110 may readily include various other elements or functionalities in addition to, or instead of, those elements or functionalities discussed in conjunction with the FIG. 1 embodiment.

In accordance with certain embodiments of the present invention, electronic device 110 is implemented as a video camcorder device that records video data and corresponding ambient audio data which are collectively referred to herein as audio/video data (AV data). However, the present invention may be successfully embodied in any appropriate electronic device or system. For example, in certain embodiments, electronic device 110 may alternately be implemented as a scanner device, an digital still camera device, a computer device, a personal digital assistant (PDA), a cellular telephone, a television, a game console, or an audio recorder. In addition, the present invention may be implemented as part of entertainment robots such as AIBO™ and QRIO™ by Sony Corporation.

In a camcorder implementation of the FIG. 1 embodiment, a system user utilizes control module 114 for instructing capture subsystem 118 via system bus 124 to capture video data corresponding to a given photographic target or scene. The captured video data is then transferred over system bus 124 to control module 114, which responsively performs various processes and functions with the video data. System bus 124 typically also bi-directionally passes various status and control signals between capture subsystem 118 and control module 114.

In the FIG. 1 embodiment, when capture subsystem 118 captures the foregoing video data, electronic device 110 simultaneously utilizes sound sensor 112 to detect and convert ambient sound energy into corresponding audio data. The captured audio data is then transferred over system bus 124 to control module 114, which responsively performs various processes and functions with the captured audio data, in accordance with the present invention.

In a camcorder implementation of the FIG. 1 embodiment, capture subsystem 118 may include, but is not limited to, an image sensor that captures image data corresponding to a photographic target via reflected light impacting the image sensor along an optical path. The image sensor may be implemented as a charge-coupled device (CCD) that generates video data representing the photographic target.

In the FIG. 1 embodiment, control module 114 includes, but is not limited to, a central processing unit (CPU) 122, a memory 130, and one or more input/output interface(s) (I/O) 126. Display 134, CPU 122, memory 130, and I/O 126 are each coupled to, and communicate, via common system bus 124 that also communicates with capture subsystem 118. In alternate embodiments, control module 114 may readily include various other components in addition to, or instead of, those components discussed in conjunction with the FIG. 1 embodiment.

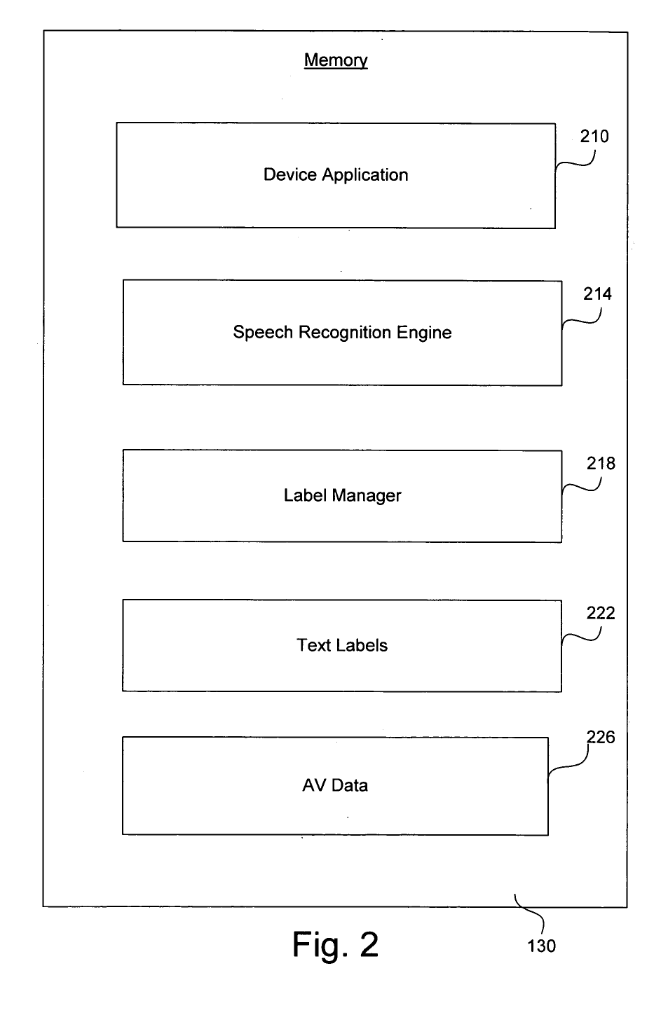

In the FIG. 1 embodiment, CPU 122 is implemented to include any appropriate microprocessor device. Alternately, CPU 122 may be implemented using any other appropriate technology. For example, CPU 122 may be implemented as an application-specific integrated circuit (ASIC) or other appropriate electronic device. In the FIG. 1 embodiment, I/O 126 provides one or more effective interfaces for facilitating bi-directional communications between electronic device 110 and any external entity, including a system user or another electronic device. I/O 126 may be implemented using any appropriate input and/or output devices. The functionality and utilization of electronic device 110 are further discussed below in conjunction with FIG. 2 through FIG. 10.

Referring now to FIG. 2, a block diagram for one embodiment of the FIG. 1 memory 130 is shown, according to the present invention. Memory 130 may comprise any desired storage-device configurations, including, but not limited to, random access memory (RAM), read-only memory (ROM), and storage devices such as floppy discs or hard disc drives. In the FIG. 2 embodiment, memory 130 includes a device application 210, speech recognition engine 214, a label manager 218, text labels 222, and audio/video data (AV data) 226. In alternate embodiments, memory 130 may readily include various other elements or functionalities in addition to, or instead of, those elements or functionalities discussed in conjunction with the FIG. 2 embodiment.

In the FIG. 2 embodiment, device application 210 includes program instructions that are preferably executed by CPU 122 (FIG. 1) to perform various functions and operations for electronic device 110. The particular nature and functionality of device application 210 typically varies depending upon factors such as the type and particular use of the corresponding electronic device 110.

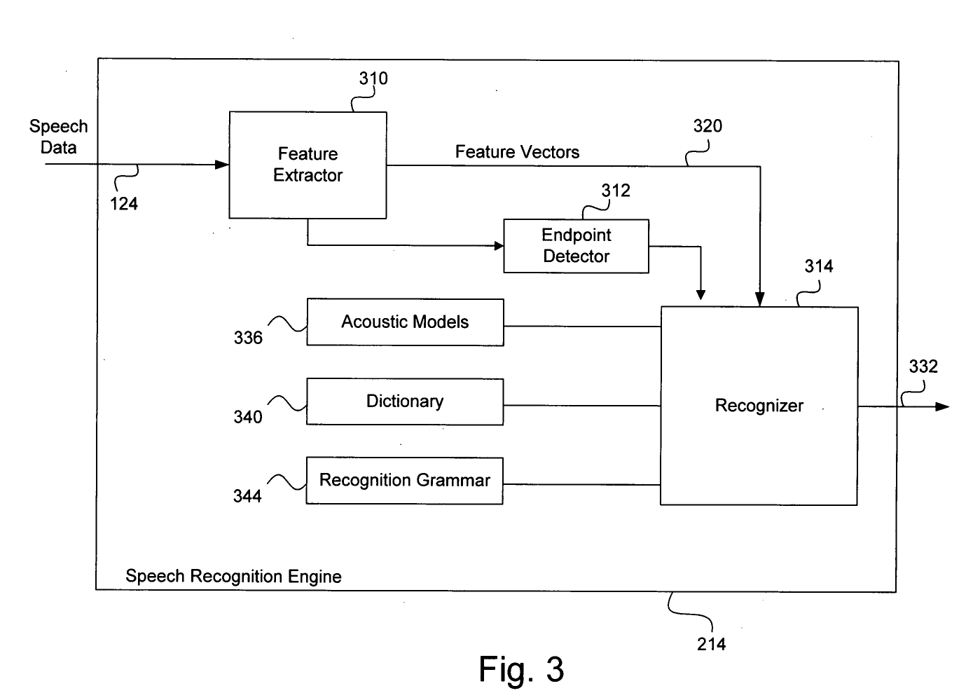

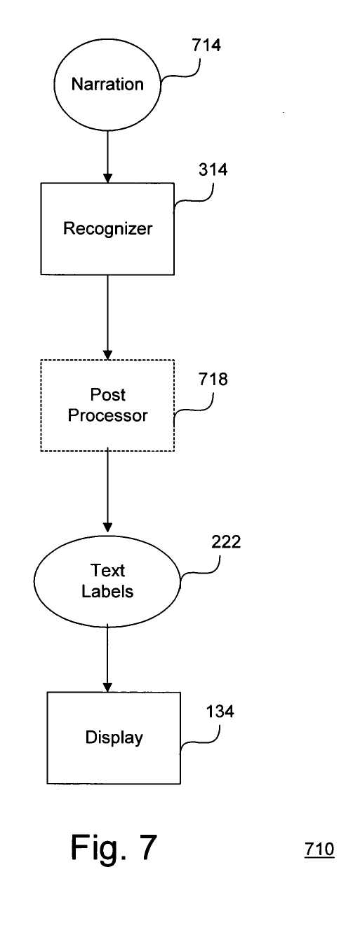

In the FIG. 2 embodiment, speech recognition engine 214 includes one or more software modules that are executed by CPU 122 to analyze and recognize input sound data. Certain embodiments of speech recognition engine 214 are further discussed below in conjunction with FIGS. 3-5. In the FIG. 2 embodiment, label manager 218 includes one or more software modules and other information for performing various automatic cataloguing procedures with text labels 222 that are generated by speech recognition engine 214, in accordance with the present invention. AV data 226 includes audio data and/or video data captured by electronic device 110, as discussed above in conjunction with FIG. 1. In various appropriate embodiments, the present invention may also be effectively utilized in conjunction with various types of data in addition to, or instead of, AV data 226. The utilization and functionality of label manager 218 are further discussed below in conjunction with FIGS. 7-10.

Referring now to FIG. 3, a block diagram for one embodiment of the FIG. 2 speech recognition engine 214 is shown, in accordance with the present invention. Speech recognition engine 214 includes, but is not limited to, a feature extractor 310, an endpoint detector 312, a recognizer 314, acoustic models 336, dictionary 340, and one or more recognition grammar 344. In alternate embodiments, speech recognition engine 214 may readily include various other elements or functionalities in addition to, or instead of, those elements or functionalities discussed in conjunction with the FIG. 3 embodiment.

In the FIG. 3 embodiment, a sound sensor 112 (FIG. 1) provides digital speech data to feature extractor 310 via system bus 124. Feature extractor 310 responsively generates corresponding representative feature vectors, which may be provided to recognizer 314 via path 320. Feature extractor 310 may further provide the speech data to endpoint detector 312, and endpoint detector 312 may responsively identify endpoints of utterances represented by the speech data to indicate the beginning and end of an utterance in time. Endpoint detector 312 may then provide the endpoints to recognizer 314. In certain embodiments endpoint detector 312 may be manually controlled with a corresponding “listen” switch.

In the FIG. 3 embodiment, recognizer 314 is configured to recognize words in a vocabulary which is represented in dictionary 340. The foregoing vocabulary in dictionary 340 corresponds to any desired commands, instructions, narration, or other audible sounds that are supported for speech recognition by speech recognition engine 214.

In practice, each word from dictionary 340 is associated with a corresponding phone string (string of individual phones) which represents the pronunciation of that word. Acoustic models 336 (such as Hidden Markov Models) for each of the phones are selected and combined to create the foregoing phone strings for accurately representing pronunciations of words in dictionary 340. Recognizer 314 compares input feature vectors from line 320 with the entries (phone strings) from dictionary 340 to determine which word produces the highest recognition score. The word corresponding to the highest recognition score may thus be identified as the recognized word.

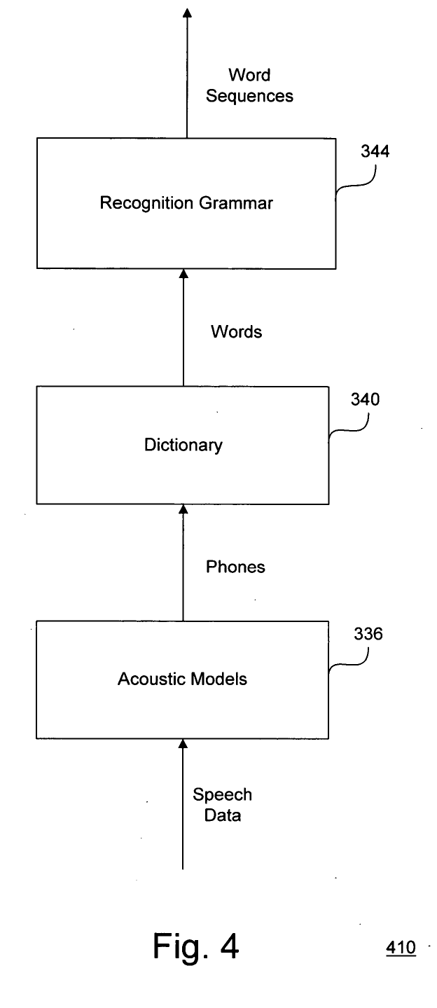

Speech recognition engine 214 also utilizes one or more recognition grammar 344 to determine specific recognized word sequences that are supported by speech recognition engine 214. Recognized sequences of vocabulary words may then be output as the foregoing word sequences from recognizer 314 via path 332. The operation and implementation of recognizer 314, dictionary 340, and recognition grammar 344 are further discussed below in conjunction with FIGS. 4-6.

Referring now to FIG. 4, a block diagram illustrating functionality of the FIG. 3 speech recognition engine 214 is shown, in accordance with one embodiment of the present invention. In alternate embodiments, the present invention may readily perform speech recognition procedures using various techniques or functionalities in addition to, or instead of, those techniques or functionalities discussed in conjunction with the FIG. 4 embodiment.

In the FIG. 4 embodiment, speech recognition engine (FIG. 3) 214 receives speech data from a sound sensor 112, as discussed above in conjunction with FIG. 3. A recognizer 314 (FIG. 3) from speech recognition engine 214 compares the input speech data with acoustic models 336 to identify a series of phones (phone strings) that represent the input speech data. Recognizer 340 references dictionary 340 to look up recognized vocabulary words that correspond to the identified phone strings. The recognizer 340 utilizes recognition grammar 344 to form the recognized vocabulary words into word sequences, such as sentences, phrases, commands, or narration, which are supported by speech recognition engine 214. In certain embodiments, the foregoing word sequences are advantageously utilized to form text labels 222 (FIG. 2) for identifying and cataloguing specific sections in captured AV data 226 (FIG. 2), in accordance with the present invention. The utilization of speech recognition engine 214 to generate text labels 222 is further discussed below in conjunction with FIGS. 7-9.

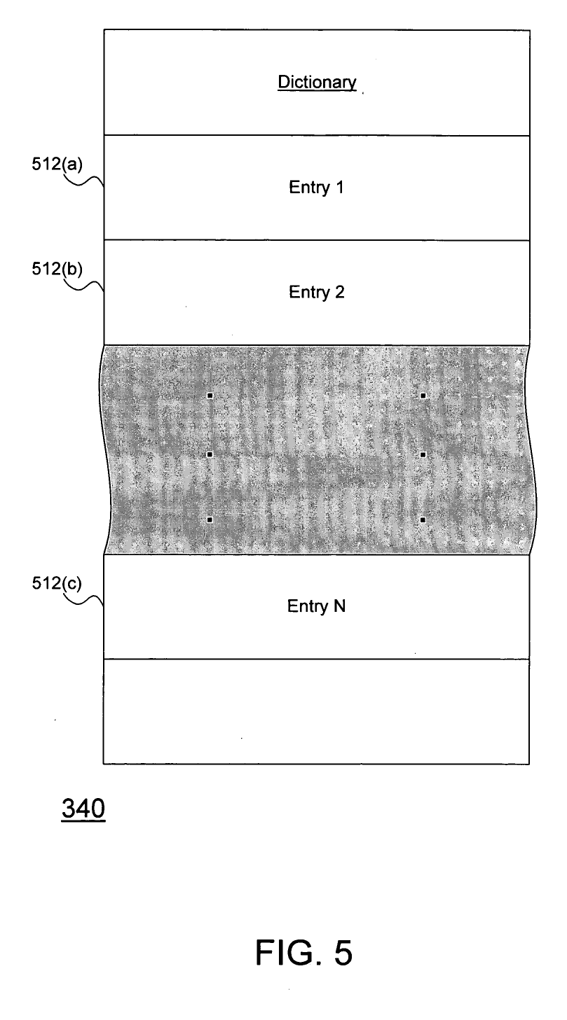

Referring now to FIG. 5, a block diagram for one embodiment of the FIG. 3 dictionary 340 is shown, in accordance with the present invention. In the FIG. 5 embodiment, dictionary 340 includes an entry 1 (512(a)) through an entry N (512(c)). In alternate embodiments, dictionary 340 may readily include various other elements or functionalities in addition to, or instead of, those elements or functionalities discussed in conjunction with the FIG. 5 embodiment.

Dictionary 340 may be implemented to include any desired number of entries 512 that may include any required type of information. However, in the FIG. 5 embodiment, dictionary 340 is implemented in a simplified manner with a minimal number of entries 512 to thereby conserve system resources and production costs for electronic device 110, while still leaving room for any words acquired through usage and customization, such as proper names or city names. In the FIG. 5 embodiment, as discussed above in conjunction with FIG. 3, each entry 512 from dictionary 340 typically includes vocabulary words and corresponding phone strings of individual phones from a pre-determined phone set. The individual phones of the foregoing phone strings form sequential representations of the pronunciations of corresponding entries 512 from dictionary 340. In certain embodiments, words in dictionary 340 may be represented by multiple pronunciations, so that more than a single entry 512 may thus correspond to the same vocabulary word.

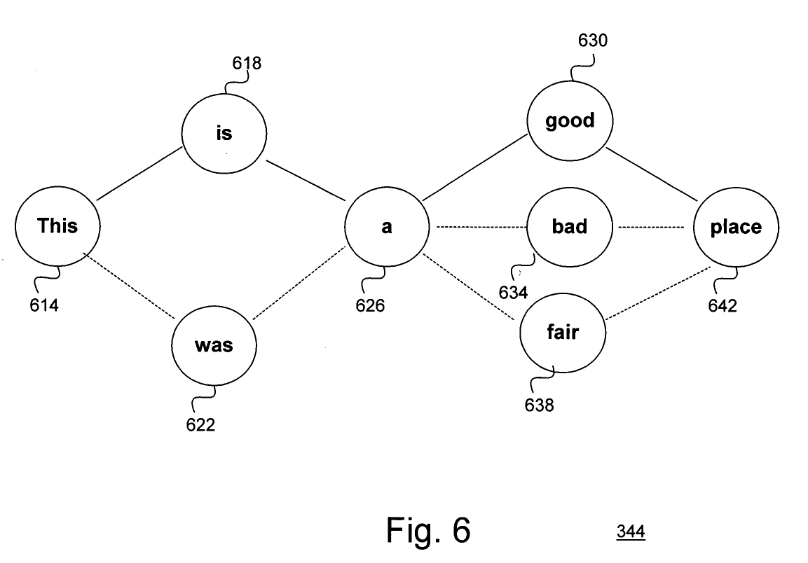

Referring now to FIG. 6, a diagram illustrating an exemplary recognition grammar 344 from FIG. 3 is shown, in accordance with one embodiment of the present invention. The FIG. 6 embodiment is presented for purposes of illustration, and in alternate embodiments, the present invention may readily perform speech recognition procedures using various techniques or functionalities in addition to, or instead of, those techniques or functionalities discussed in conjunction with the FIG. 6 embodiment.

In the FIG. 6 embodiment, recognition grammar 344 includes a network of word nodes 614, 618, 622, 626, 630, 634, 638, and 642 that collectively represent various possible sequences of words that are supported by speech recognition engine 214. Each node uniquely represents a single vocabulary word, and the supported word sequences are arranged in time, from left to right in FIG. 6, with initial words being located on the left side of FIG. 6, and final words being located on the right side of FIG. 6.

In the FIG. 6 example, recognizer 314 utilizes dictionary 340 to generate the vocabulary words “This is a good place.” In response, recognition grammar 344 identifies corresponding word nodes 614, 618, 626, 630, and 642 (This is a good place) as being a word sequence that is supported by recognition grammar 344. Recognizer 314 therefore outputs the foregoing word sequence as a recognized text label 222 for utilization by electronic device 110. In certain embodiments, recognition grammar 344 may be implemented by utilizing finite state machine technology or stochastic language models.

In certain situations, the FIG. 6 recognition grammar 344 modifies phone strings received from dictionary 340 by disregarding certain additional or extraneous words or sounds that are not supported by speech recognition engine 214 for inclusion in text labels 222. Through the utilization of a compact dictionary 340 with a limited number of entries 512, and one or more pre-defined recognition grammar 344 that prescribe only a limited number of supported word sequences, speech recognition engine 214 may therefore be implemented with an economical and simplified design that conserves system resources such as processing requirements, memory capacity, and communication bandwidth.

Referring now to FIG. 7, a block diagram illustrating an information flow is shown, in accordance with one embodiment of the present invention. In alternate embodiments, the present invention may perform cataloguing procedures that include various other elements and functionalities in addition to, or instead of, those elements or functionalities discussed in conjunction with the FIG. 7 embodiment.

In the FIG. 7 embodiment, a system user utilizes electronic device 110 (FIG. 1) to capture AV data 226 (FIG. 2) while simultaneously providing a verbal narration 714 that is recorded as part of AV data 226. In the FIG. 7 embodiment, narration 714 may include, but is not limited to, appropriate words, phrases, or sentences typically relating to the photographic subject matter of AV data 226. In the FIG. 7 embodiment, since narration 714 is often generated from a location that is relatively close to sound sensor 112 (FIG. 1), narration 714 therefore may have a relatively greater volume/amplitude than other ambient sound that is recorded as part of AV data 226. In certain embodiments, sound sensor 112 may be implemented in a non-integral manner with respect to electronic device 110. For example, sound sensor 112 may be implemented as a wireless/wired head-mounted sound sensor device.

In the FIG. 7 embodiment, when a system user or other appropriate entity places electronic device 110 into a label mode by communicating with a label manager 218, a recognizer 314 of a speech recognition engine responsively performs a speech recognition procedure upon AV data 226 to automatically generate text labels 222 that are primarily based upon narration 714. In certain embodiments, the system user enters the foregoing label mode by utilizing speech recognition engine 214 to recognize appropriate verbal label-mode commands that are provided to label manager 218. In the FIG. 7 embodiment, recognizer 314 or endpoint detector 312 may identify narration 714 as having a relatively greater volume/amplitude than other ambient sound that is recorded as part of AV data 226. In certain embodiments, speech recognition engine 214 or other appropriate entity may generate text labels 222 based upon various other events in AV data 226. For example, text labels 222 may be generated in response to ambient sound present in AV data 226. In the FIG. 7 embodiment, recognizer 314 performs the foregoing speech recognition procedures using a compact dictionary 340 and one or more recognition grammar 344 to effectively conserve system resources for electronic device 110, as discussed above in conjunction with FIGS. 3-6.

In the FIG. 7 embodiment, label manager 218 may optionally instruct a post processor 718 to perform appropriate post-processing functions on text labels 222. For example, in certain embodiments, post processor 718 performs a validation procedure using one or more confidence measures to eliminate invalid text strings 222 that fail to satisfy certain pre-determined criteria such as label amplitude or label duration. Text labels 222 are then stored in any appropriate manner. For example, label manager 218 may store each of text labels 222 at different subject matter locations in AV data 226 depending upon where the corresponding original narration 714 occurred. Text labels 222 may also be stored separately in memory 130 along with certain meta-information (such as video timecode) that identifies the specific subject matter locations in AV data 226 that correspond to respective text labels 222.

In the FIG. 7 embodiment, in a label search mode, label manager 218 generates a label search graphical user interface (GUI) upon display 134 of electronic device 110 to enable a system user to utilize text labels 222 for performing a label search procedure to thereby locate corresponding sections of AV data 226. In certain embodiments, the label search GUI includes, but is not limited to, a list of text labels 222 from AV data 226 along with corresponding respective thumbnail images of the associated video locations in AV data 226. In certain embodiments, the system user enters the foregoing label mode by utilizing speech recognition engine 214 to recognize appropriate verbal label-search commands that are provided to label manager 218.

A system user may then select one or more desired search labels from text labels 222 by using any appropriate means. For example, the system user may select a search label by utilizing speech recognition engine 214 to recognize appropriate verbal selection commands or key words that are provided to label manager 218. In alternate embodiments, the system user may select text labels 222 by utilizing speech recognition engine 214 without viewing any type of visual user interface such as the foregoing label search GUI. In the FIG. 7 embodiment, after a text label 222 has been selected by a system user, then label manager 218 instructs electronic device 110 to automatically locate and display the corresponding section of AV data 226. For at least the foregoing reasons, the present invention effectively provides an improved system and method for automatically cataloguing AV data by utilizing speech recognition procedures.

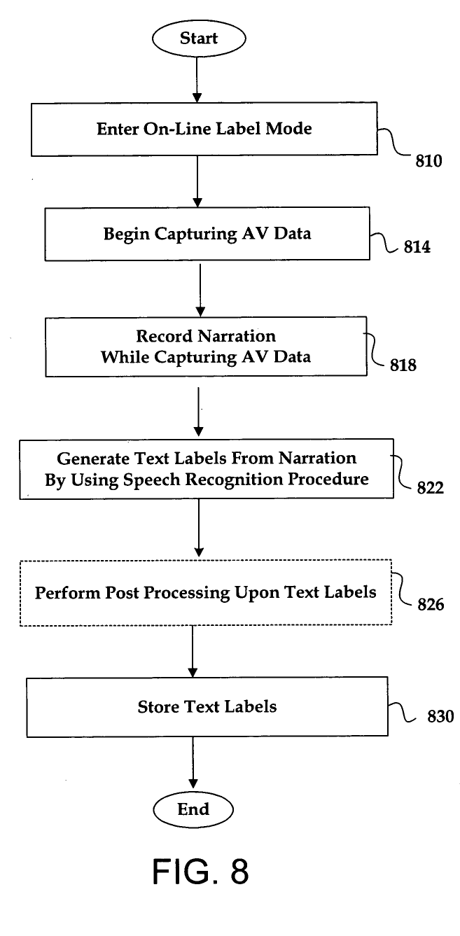

Referring now to FIG. 8, a flowchart of method steps for performing a real-time cataloguing procedure is shown, in accordance with one embodiment of the present invention. The FIG. 8 flowchart is presented for purposes of illustration, and in alternate embodiments, the present invention may readily utilize various steps and sequences other than those discussed in conjunction with the FIG. 8 embodiment.

In the FIG. 8 embodiment, in step 810, a system user or other appropriate entity initially instructs a label manager 218 of electronic device 110 to enter a real-time label mode by utilizing any effective techniques. For example, the system user may use a verbal command that is recognized by a speech recognition engine 214 of electronic device 110 to enter the foregoing real-time mode. In step 814, electronic device 110 begins to capture and store AV data 226 corresponding to selected photographic subject matter. In step 818, electronic device 110 records and stores a narration 714 together with the foregoing AV data 226. In the FIG. 8 embodiment, narration 714 may include any desired audio information provided by the system user, a narrator, or other ambient sound sources.

In step 822, label manager 218 instructs speech recognition engine 214 to analyze AV data 226 for generating corresponding text labels 222 by utilizing appropriate speech recognition procedures, as discussed above in conjunction with FIGS. 3-6. In the FIG. 8 embodiment, speech recognition engine 214 is effectively implemented in a simplified configuration to conserve system resources such as processing power, memory capacity, and communication bandwidth.

In step 826, label manager 218 may optionally instruct a post processor 718 to perform appropriate post-processing operations upon text labels 222. For example, in certain embodiments, post processor 718 performs a label analysis procedure using one or more confidence measures to eliminate invalid text strings 222 that fail to satisfy certain pre-determined criteria. Finally, in step 830, label manager 218 stores text labels 222 in any appropriate manner. For example, label manager 218 may store each of text labels 222 at different subject matter locations in AV data 226 depending upon where the corresponding original narration 714 occurred. Text labels 222 may also be stored separately in memory 130 along with certain meta-information (such as video timecode) that identifies specific subject matter locations in AV data 226 that correspond to respective text labels 222. The FIG. 8 process may then terminate.

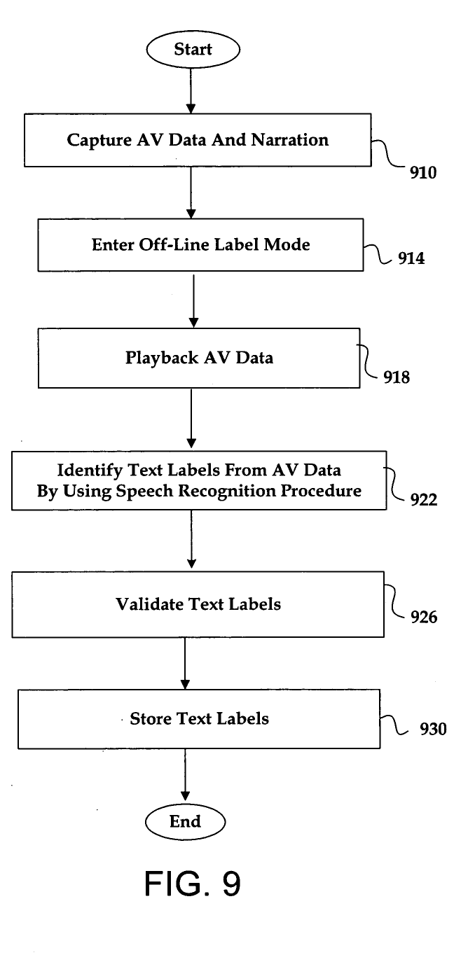

Referring now to FIG. 9, a flowchart of method steps for performing a non-real-time cataloguing procedure is shown, in accordance with one embodiment of the present invention. The FIG. 9 flowchart is presented for purposes of illustration, and in alternate embodiments, the present invention may readily utilize various steps and sequences other than those discussed in conjunction with the FIG. 9 embodiment.

In the FIG. 9 embodiment, in step 910, electronic device 110 begins to capture and store AV data 226 corresponding to selected photographic subject matter. In step 910, electronic device 110 also records and stores a narration 714 together with the foregoing AV data 226. In the FIG. 9 embodiment, narration 714 may include any desired audio information provided by a system user, a narrator, or other ambient sound sources.

In step 914, after AV data 226 and narration 714 have been captured by electronic device 110, a system user or other appropriate entity instructs a label manager 218 of electronic device 110 to enter a non-real-time label mode by utilizing any effective techniques. For example, the system user may use a verbal label-mode command that is recognized by a speech recognition engine 214 of electronic device 110 to enter the foregoing non-real-time mode.

In step 918, label manager 218 instructs electronic device 110 to begin playing back the captured AV data 226. In step 922, label manager 218 instructs speech recognition engine 214 to analyze AV data 226 during the foregoing playback procedure of step 918 to thereby generate corresponding text labels 222 by utilizing appropriate speech recognition procedures, as discussed above in conjunction with FIGS. 3-6. In the FIG. 9 embodiment, speech recognition engine 214 is effectively implemented in a simplified configuration to conserve system resources such as processing power, memory capacity, and communication bandwidth. In step 922, label manager 218 may also optionally instruct a post processor 718 to perform appropriate post-processing operations upon text labels 222. For example, in certain embodiments, post processor 718 performs a label analysis procedure using one or more confidence measures to eliminate invalid text strings 222 that fail to satisfy certain pre-determined criteria.

In step 926, label manager 218 coordinates a label validation procedure for validating text labels 222. For example, in certain embodiments, label manager 218 provides means for a system user or other appropriate entity to evaluate text labels 222. In certain embodiments, label manager 218 generates a validation graphical user interface (GUI) upon display 134 of electronic device 110 for a system user to interactively evaluate, delete, and/or edit text labels 222 by using any effective techniques. In certain embodiments, the system user may use verbal validation instructions that are recognized by speech recognition engine 214 to validate or edit text labels 222 during the foregoing label validation procedure.

Finally, in step 930, label manager 218 stores text labels 222 in any appropriate manner. For example, label manager 218 may store each of text labels 222 at different subject matter locations in AV data 226 depending upon where the corresponding original narration 714 occurred. Text labels 222 may also be stored separately in memory 130 along with certain meta-information (such as video timecode) that identifies specific subject matter locations in AV data 226 that correspond to respective text labels 222. The FIG. 9 process may then terminate.

The FIG. 9 embodiment discusses the foregoing non-real-time cataloguing procedure as being performed by the same electronic device 110 that captured AV data 226 and narration 714. However, in alternate embodiments, the present invention may readily capture AV data 226 with electronic device 110, and may then perform various non-real-time procedures upon AV data 226 by utilizing any other appropriate electronic device or system including, but not limited to, a computer device or an electronic network device.

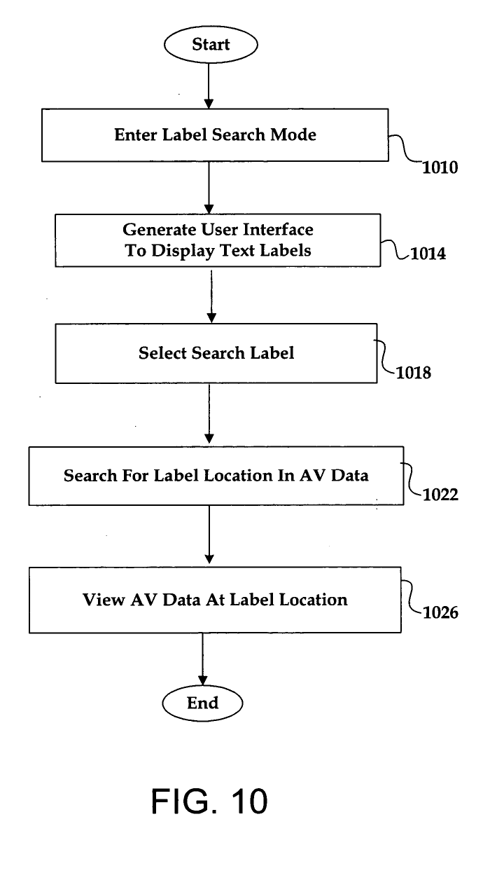

Referring now to FIG. 10, a flowchart of method steps for performing a label search procedure is shown, in accordance with one embodiment of the present invention. The FIG. 10 flowchart is presented for purposes of illustration, and in alternate embodiments, the present invention may readily utilize various steps and sequences other than those discussed in conjunction with the FIG. 10 embodiment.

In the FIG. 10 embodiment, in step 1010, a system user or other appropriate entity initially instructs a label manager 218 of electronic device 110 to enter a label search mode by utilizing any effective techniques. For example, the system user may use a verbal search-mode command that is recognized by a speech recognition engine 214 of electronic device 110 to enter the foregoing label search mode. In step 1014, label manager 218 generates a label-search graphical user interface (label search GUI) on display 134 of electronic device 110 to display text labels 222 corresponding to captured AV data 226. The label search GUI may be implemented in any effective manner. In certain embodiments, the label search GUI includes, but is not limited to, a list of text labels 222 from AV data 226 along with corresponding respective thumbnail images of associated video locations in AV data 226.

In step 1018, a system user or other appropriate entity selects a search label from the text labels 222 displayed on the label search GUI for performing the label search procedure. In certain embodiments, the system user may use a verbal selection command that is recognized by speech recognition engine 214 of electronic device 110 to select the foregoing search label from text labels 222.

In step 1022, label manager 218 instructs electronic device 110 to automatically search for a specific label location in AV data 226 corresponding to the selected search label from text labels 222. Finally, in step 1026, the system user may view AV data 226 at the specific label location corresponding to the search label selected from text labels 222. The present invention therefore effectively provides an improved system and method for automatically cataloguing AV data by utilizing speech recognition procedures.

The invention has been explained above with reference to certain preferred embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

1. A system for cataloguing electronic information, comprising:
an electronic device that captures audio/video data corresponding to a photographic target, said audio/video data including a narration provided by a narrator;
a speech recognition engine that automatically performs a speech recognition process upon said narration to generate labels that correspond to respective subject matter locations in said audio/video data; and
a label manager that manages a label mode for generating and storing said labels, said label manager also controlling a label search mode for utilizing said labels to locate said respective subject matter locations in said audio/video data.

2. The system of claim 1 wherein said electronic device is implemented as an audio/video camcorder device.

3. The system of claim 1 wherein said speech recognition engine is configured in a simplified configuration that efficiently compares said narration with acoustic models to identify phone strings that represent said narration, said speech recognition engine referencing a compact dictionary to look up recognized vocabulary words that correspond to said phone strings, said speech recognition engine utilizing a limited set of recognition grammar to form said recognized vocabulary words into said labels that are supported by said speech recognition engine.

4. The system of claim 1 wherein said label manager initially instructs said electronic device to enter a real-time label mode for creating and storing said labels, said electronic device concurrently capturing said audio/video data and said narration after said label manager instructs said electronic device to enter said real-time label mode.

5. The system of claim 1 wherein said electronic device enters a real-time label mode in response to a verbal label-mode command from a system user, said verbal label-mode command being recognized and provided to said label manager by said speech recognition engine.

6. The system of claim 1 wherein said speech recognition engine automatically generates said labels as said electronic device captures said audio/video data and said narration.

7. The system of claim 1 wherein a post processor performs a post-processing procedure upon said labels in a real-time label mode, said post-processing procedure including a validation procedure using one or more confidence measures to eliminate invalid labels that fail to satisfy pre-determined validation criteria.

8. The system of claim 1 wherein said label manager stores said labels during a real-time label mode, said labels being stored along with meta-information that associates each of said respective subject matter locations to a corresponding one of said labels.

9. The system of claim 1 wherein said electronic device initially captures said audio/video data and said narration prior to entering said label mode.

10. The system of claim 1 wherein said label manager instructs said electronic device to enter a non-real-time label mode for creating and storing said labels, said electronic device responsively retrieving and playing back said audio/video data and said narration.

11. The system of claim 1 wherein said speech recognition engine automatically generates said labels by analyzing said audio/video data and said narration as said electronic device plays back said audio/video data and said narration.

12. The system of claim 1 wherein a post processor performs a post-processing procedure upon said labels in a non-real-time label mode, said post-processing procedure including a validation procedure using one or more confidence measures to eliminate invalid labels that fail to satisfy pre-determined validation criteria.

13. The system of claim 1 wherein said label manager coordinates a label validation procedure for validating said labels, said label manager generating a validation graphical user interface upon a display of said electronic device for a system user to interactively evaluate, delete, and edit said labels.

14. The system of claim 1 wherein said label manager coordinates a label validation procedure for validating said labels in response to verbal validation commands from a system user, said verbal validation commands being recognized and provided to said label manager by said speech recognition engine.

15. The system of claim 1 wherein said label manager stores said labels in a non-real-time label mode, said labels being stored along with meta-information that associates each of said respective subject matter locations to a corresponding one of said labels.

16. The system of claim 1 wherein said label manager instructs said electronic device to enter said label search mode during which a system user interactively selects a search label for performing a label search procedure to locate a specific one of said respective subject matter locations corresponding to said search label.

17. The system of claim 1 wherein said label manager generates a label-search GUI on a display of said electronic device, a system user viewing said labels and corresponding representative images from said audio/video data for selecting a search label.

18. The system of claim 1 wherein a system user selects a search label by issuing a verbal search-label command, said verbal search-label command being recognized and provided to said label manager by said speech recognition engine.

19. The system of claim 1 wherein said label manager instructs said electronic device to automatically locate and retrieve a specific one of said respective subject matter locations in response to a system user selecting a search label.

20. The system of claim 1 wherein said electronic device automatically plays back a specific retrieved one of said respective subject matter locations from said audio/video data for viewing by said system user.

21. A method for cataloguing electronic information, comprising:
capturing audio/video data corresponding to a photographic target by utilizing an electronic device, said audio/video data including a narration provided by a narrator;
providing a speech recognition engine that automatically performs a speech recognition process upon said narration to generate text labels that correspond to respective subject matter locations in said audio/video data;
managing a label mode for generating and storing said text labels by utilizing a label manager; and
controlling a label search mode with said label manager, said label search mode utilizing said text labels to locate said respective subject matter locations in said audio/video data.

22. The method of claim 21 wherein said electronic device is implemented as an audio/video camcorder device.

23. The method of claim 21 wherein said speech recognition engine is configured in a simplified configuration that efficiently compares said narration with acoustic models to identify phone strings that represent said narration, said speech recognition engine referencing a compact dictionary to look up recognized vocabulary words that correspond to said phone strings, said speech recognition engine utilizing a limited set of recognition grammar to form said recognized vocabulary words into said text labels that are supported by said speech recognition engine.

24. The method of claim 21 wherein said label manager initially instructs said electronic device to enter a real-time label mode for creating and storing said text labels, said electronic device concurrently capturing said audio/video data and said narration after said label manager instructs said electronic device to enter said real-time label mode.

25. The method of claim 21 wherein said electronic device enters a real-time label mode in response to a verbal label-mode command from a system user, said verbal label-mode command being recognized and provided to said label manager by said speech recognition engine.

26. The method of claim 21 wherein said speech recognition engine automatically generates said text labels as said electronic device captures said audio/video data and said narration.

27. The method of claim 21 wherein a post processor performs a post-processing procedure upon said text labels in a real-time label mode, said post-processing procedure including a validation procedure using one or more confidence measures to eliminate invalid text labels that fail to satisfy pre-determined validation criteria.

28. The method of claim 21 wherein said label manager stores said text labels during a real-time label mode, said text labels being stored along with meta-information that associates each of said respective subject matter locations to a corresponding one of said text labels.

29. The method of claim 21 wherein said electronic device initially captures said audio/video data and said narration prior to entering said label mode.

10. The method of claim 21 wherein said label manager instructs said electronic device to enter a non-real-time label mode for creating and storing said text labels, said electronic device responsively retrieving and playing back said audio/video data and said narration.

31. The method of claim 21 wherein said speech recognition engine automatically generates said text labels by analyzing said audio/video data and said narration as said electronic device plays back said audio/video data and said narration.

32. The method of claim 21 wherein a post processor performs a post-processing procedure upon said text labels in a non-real-time label mode, said post-processing procedure including a validation procedure using one or more confidence measures to eliminate invalid text labels that fail to satisfy pre-determined validation criteria.

33. The method of claim 21 wherein said label manager coordinates a label validation procedure for validating said text labels, said label manager generating a validation graphical user interface upon a display of said electronic device for a system user to interactively evaluate, delete, and edit said text labels.

34. The method of claim 21 wherein said label manager coordinates a label validation procedure for validating said text labels in response to verbal validation commands from a system user, said verbal validation commands being recognized and provided to said label manager by said speech recognition engine.

35. The method of claim 21 wherein said label manager stores said text labels in a non-real-time label mode, said text labels being stored along with meta-information that associates each of said respective subject matter locations to a corresponding one of said text labels.

36. The method of claim 21 wherein said label manager instructs said electronic device to enter said label search mode during which a system user interactively selects a search label for performing a label search procedure to locate a specific one of said respective subject matter locations corresponding to said search label.

37. The method of claim 21 wherein said label manager generates a label-search GUI on a display of said electronic device, a system user viewing said text labels and corresponding representative images from said audio/video data for selecting a search label.

38. The method of claim 21 wherein a system user selects a search label by issuing a verbal search-label command, said verbal search-label command being recognized and provided to said label manager by said speech recognition engine.

39. The method of claim 21 wherein said label manager instructs said electronic device to automatically locate and retrieve a specific one of said respective subject matter locations in response to a system user selecting a search label.

40. The method of claim 21 wherein said electronic device automatically plays back a specific retrieved one of said respective subject matter locations from said audio/video data for viewing by said system user.

41. A computer-readable medium comprising program instructions for cataloguing electronic information by:
capturing audio/video data corresponding to a photographic target by utilizing an electronic device, said audio/video data including a narration provided by a narrator;
providing a speech recognition engine that automatically performs a speech recognition process upon said narration to generate text labels that correspond to respective subject matter locations in said audio/video data;
managing a label mode for generating and storing said text labels by utilizing a label manager; and
controlling a label search mode with said label manager, said label search mode utilizing said text labels to locate said respective subject matter locations in said audio/video data.

42. A system for cataloguing electronic information, comprising:
means for capturing audio/video data corresponding to a photographic target, said audio/video data including a narration provided by a narrator;
means for automatically performing a speech recognition process upon said narration to generate text labels that correspond to respective subject matter locations in said audio/video data;
means for managing a label mode to generate and store said text labels; and
means for controlling a label search mode that utilizes said text labels to locate said respective subject matter locations in said audio/video data.

43. A system for cataloguing electronic information, comprising:
an imaging device that captures audio/video data corresponding to selected photographic targets, said audio/video data including a verbal narration provided by a narrator;
a speech recognition engine that automatically performs a speech recognition process upon said narration to generate text labels that are based upon said narration, said text labels corresponding to respective subject matter locations in said audio/video data, said text labels including abbreviated word sequences that identify said selected photographic targets; and
a label manager that manages a label mode during which said text labels are generated by said speech recognition engine, said label manager also storing said text labels during said label mode, said text labels being stored along with meta-information that associates said respective subject matter locations to corresponding ones of said text labels, said label manager also controlling a label search mode for utilizing said text labels to locate specific corresponding ones of said respective subject matter locations from said audio/video data, said label manager providing a label-search user interface upon a display of said imaging device for displaying said text labels and corresponding visual images of said respective subject matter locations from said audio/video data, a system user interactively choosing a selected text label by utilizing said label-search user interface, said imaging device responsively displaying said audio/video data from a selected subject matter location corresponding only to said selected text label.

44. A system for cataloguing electronic information, comprising:
an electronic device that captures said electronic information that includes verbal narration data;
a speech recognition engine that analyzes said electronic information to generate labels that correspond to respective subject matter locations in said electronic information; and
a label manager that utilizes said labels to locate said respective subject matter locations in said electronic information.

45. A system for cataloguing electronic information, comprising:
an electronic device that captures audio/video data corresponding to a photographic target, said audio/video data including a narration provided by a narrator; and
a speech recognition engine that automatically performs a speech recognition process upon said audio/video data to generate labels that correspond to respective subject matter locations in said audio/video data.

46. A system for cataloguing electronic information, comprising:
an electronic device that captures audio/video data corresponding to a photographic target, said audio/video data including a narration provided by a narrator; and
a label manager that controls a label search mode for utilizing labels derived from said narration to locate corresponding respective subject matter locations in said audio/video data.

47. An electronic cataloguing system implemented by:
capturing electronic data which includes a narration provided by a narrator;
performing a speech recognition process upon said electronic data to automatically generate labels that correspond to respective subject matter locations in said electronic data; and
utilizing said labels to locate said respective subject matter locations in said electronic data.
